(19) United States
(12) Patent Application Publication
(10) Pub. No.: US 2021/0039978 A1
(43) Pub. Date: Feb. 11, 2021

(54) OPAQUE QUARTZ GLASS AND METHOD FOR MANUFACTURING THE SAME

(71) Applicant: Tosoh Quartz Corporation, Yamagata-shi, Yamagata (JP)

(72) Inventors: Minoru KUNIYOSHI, Yamagata-shi, Yamagata (JP); Yukihiro SUGANO, Yamagata-shi, Yamagata (JP); Chiemi ITO, Yamagata-shi, Yamagata (JP); Takaya SUZUKI, Yamagata-shi, Yamagata (JP)

(21) Appl. No.: 16/978,422

(22) PCT Filed: Mar. 9, 2018
(86) PCT No.: PCT/JP2018/009221

§ 371 Date: Sep. 4, 2020

(51) Int. Cl. C03B 19/08; C03B 19/09; C03B 20/00; C03C 11/00; C03C 3/06

(52) U.S. Cl. CPC C03B 19/08; C03B 19/09; C03C 3/06; C03C 11/00; C03B 20/00

(57) ABSTRACT

To provide an opaque quartz glass having excellent heat insulating property, mechanical strength and surface smoothness, a silica powder water slurry of concentration of 45 to 75 wt % is subjected to wet pulverization with silicon nitride beads having a mean diameter of 0.1 mm to 3 mm. The silica powder and silicon nitride beads are subjected to abrasion and the silicon nitride powder works as foaming agent and independent spherical bubbles are formed for manufacturing opaque quartz glass which has air cells having a mean diameter of 2 to 30 μm and are independent spherical, having a density of 1.90 to 2.20 g/cm³, a whiteness of 80 or more, a reflectance of 80% or more for light of a wavelength of 0.2 to 3 μm at thickness of 3 mm, a bending strength of 70 MPa or more, a surface roughness Ra of the baked surface of 0.7 μm or less.

### TECHNICAL FIELD OF THE INVENTION

The present invention relates to an opaque quartz glass having excellent property of heat ray shielding, mechanical strength, and surface smoothness, and a method for manufacturing the same. More specifically, the present invention relates to an opaque quartz glass that can be suitably applicable to a member for a semiconductor manufacturing apparatus, a component of an optical device, and the like, and a manufacturing method thereof.

### BACKGROUND TECHNOLOGY

Quartz glass is excellent in translucency, heat resistance, and chemical resistance, and is therefore used in various applications such as lighting equipment, optical equipment parts, semiconductor industry members, and physics and chemistry equipment. Among them, opaque quartz glass containing bubbles in quartz glass has been used for a flange of a semiconductor heat treatment apparatus and a core tube because of its excellent heat ray-shielding property. Further, because of its excellent light-shielding property, it is also used as an optical device component such as a reflector base material of a light source lamp for a projector.

Conventionally, as a method for producing opaque quartz glass, a method in which a foaming agent such as silicon nitride is added to crystalline silica or amorphous silica by dry mixing and melted by an oxyhydrogen flame (for example, Patent Document 1 and Patent Document 2) are known. However, this manufacturing method and the manufactured opaque quartz glass have the following problems.
(1) Since the foaming agent is dissipated during the melting procedure, it is necessary to add a large amount of foaming agent to obtain proper opacity.
(2) Since the foaming agent that is not uniformly mixed and agglomerated vaporizes to form bubbles, the bubbles become rather large and the mechanical strength and the light reflectance of the opaque quartz glass decrease.
(3) Since the air bubbles are comparatively large, the baked surface of the opaque quartz glass becomes rough, and when the opaque quartz glass is used as the flange member, the adhesion with the device deteriorates, causing leakage. Further, when it is used as a reflector base material, the light of the lamp may leak, which may adversely affect electronic components inside the projector.

On the other hand, a method of heating a molded body of amorphous silica powder at a temperature below its melting temperature without adding a foaming agent, interrupting heat treatment before completely densifying, and partially sintering (for example, Patent Document 2) has also been proposed. The opaque quartz glass produced by this production method can reduce the mean diameter of bubbles, but if the bubbles are sintered until they become closed bubbles, the density of the bubbles will be reduced and the infrared reflectance will decrease. And also, there is a problem that the mechanical strength is lowered because the stress is concentrated on the edge of the bubble because the bubble is not completely spherical.

### PRIOR ART DOCUMENT

### Patent Document

[Patent Document 1] Japanese Patent No. 3043032

[Patent Document 2] Japanese Patent No. 3394323

### DISCLOSURE OF THE INVENTION

### Problems to be Solved by the Invention

An objective of the present invention is to solve the above described problems and to provide an opaque quartz glass having excellent in heat ray shielding property, mechanical strength and surface smoothness.

### Means for Solving the Problems

By using silicon nitride beads as a grinding medium, wet-grinding a slurry in which silica powder is dispersed in water, silicon nitride generated by abrasion of the silicon nitride beads is added as a foaming agent, and the slurry is spray-dried and granulated. By melting the molten raw material, it is possible to obtain an opaque quartz glass in which the shape of the bubbles is independent spherical and the mean diameter is 2 to 30 μm, which has excellent heat ray-shielding properties and mechanical strength, and of which the baked surface has a good smoothness.

The opaque quartz glass of the present invention contains spherical bubbles having a mean diameter of 2 to 30 μm, preferably 5 to 25 μm, more preferably 8 to 10 μm. When the mean bubble diameter is less than 2 μm, the light scattering becomes weak, and when the mean bubble diameter is more than 30 μm, the light scattering becomes weak and the flatness of the quartz glass surface and the sealing property becomes worse.

The opaque quartz glass of the present invention contains closed spherical bubbles inside the body. If the shape of the bubble is not spherical, stress concentrates at the edge of the bubble, resulting in a decrease in mechanical strength.

The whiteness of the opaque quartz glass of the present invention is 80 or more. For whiteness, the whiteness was defined as the lightness measured according to JIS Z 8722 using a color difference meter. When the whiteness is less than 80, the heat ray shielding property is deteriorated and the heat insulating property decreases.

The opaque quartz glass of the present invention has a reflectance of 80% or more for light having a wavelength of 0.2 to 3 μm when the glass thickness is 3 mm. If the reflectance is less than 80%, like the lightness, the heat ray blocking property is lowered and the heat insulating property is lowered.

The density of the opaque quartz glass of the present invention is 1.90 to 2.20 g/cm³. If the density is less than 1.90 g/cm³, the mechanical strength decreases. On the other hand, the density exceeds 2.20 g/cm³, a volume of the bubbles is reduced, and consequently, the light scattering ability is weakened, and the heat ray insulation ability is decreases.

The bending strength of the opaque quartz glass of the present invention is 70 MPa or more. If the bending strength is less than 70 MPa, there is a high risk of damage when applied to, for example, a flange of a semiconductor manufacturing apparatus or a core tube.

The surface roughness Ra of the baked surface of the opaque quartz glass of the present invention is 0.7 μm or less and more preferably 0.6 μm or less. If the surface roughness Ra of the baked surface exceeds 0.7 μm, the adhesion of the adhesive surface to the device deteriorates, which may cause leakage when used, for example, as a flange. Further, when used as a reflector base material of a light source lamp of a projector, the light of the lamp leaks and adversely affects electronic devices installed inside the projector.

The manufacturing method of the present invention will be described hereinafter.

The production method of the present invention is characterized in that when wet pulverizing a slurry in which silica powder is dispersed in water, silicon nitride beads work as a pulverizing medium and also the silicon nitride powder produced by abrading the silicon nitride beads is used as a foaming agent. Further, a granulated powder obtained by spray-drying and granulating the slurry is used as a raw material which is subjected to melting for manufacturing opaque quartz.

Hereinafter, each step of the process is described in detail. It should be noted that, as can be said in all the steps, it is important to avoid contaminations of the equipment to be used therefore the equipment should be selected with care.

(1) Selection of Raw Material Powder

The production method of the silica powder is not limited, and for example, an amorphous silica powder produced by hydrolysis of silicon alkoxide, a silica powder produced by hydrolyzing silicon tetrachloride with an oxyhydrogen flame, or the like is acceptable. Further, powder obtained by crushing natural quartz or fumed silica also can be used.

The mean particle size of the silica powder is preferably 300 μm or less. If the mean particle size exceeds 300 μm and is too large, it takes a long time to wet-mill the silica powder, resulting in a decrease in productivity and an increase in production cost, which is not preferable.

(2) Slurry Preparation

The concentration of the slurry in which silica powder is dispersed in water is 45 to 75 wt %, preferably 60 to 70 wt %. When it exceeds 75 wt %, the viscosity of the slurry becomes high and it becomes impossible to conduct wet grinding. If the concentration is less than 45 wt %, the amount of water is large and the amount of heat required for drying becomes large, which leads to a decrease in productivity and an increase in production cost, which is not desirable.

(3) Addition of Foaming Agent

As the foaming agent of this invention, silicon nitride which is obtained by abrading silicon nitride beads is used. The mean diameter of the silicon nitride beads is preferably 0.1 to 3 mm. If the mean diameter of the silicon nitride beads is larger than 3 mm, the contact area of the beads is reduced and the volume of wear of the beads is reduced, so that it takes a long time to add the foaming agent. On the other hand, if the mean diameter of the beads is smaller than 0.1 mm, the contact area of the beads increases, so that the amount of wear of the beads increases and it becomes difficult to control the amount of the added foaming agent.

As a device for abrading silicon nitride beads, a bead mill, a ball mill, a vibration mill or an attritor can be used. Particularly, a bead mill is preferable.

The amount of silicon nitride as a foaming agent added to the silica powder is 0.1 to 100 ppm, preferably 1 to 50 ppm. If the amount of silicon nitride added as foaming agent is less than 0.1 ppm, the amount of silicon nitride is not sufficient and whitening and opacity of the opaque silicon product is insufficient, and when it exceeds 100 ppm, generated bubbles are put together with each other and the final combined bubble diameter becomes too large and consequently whiteness of the opaque quartz glass decreases.

The amount of the foaming agent added to the silica powder can be adjusted to 0.1 to 100 ppm by changing the grinding duration time of the silica powder using the silicon nitride beads. Further, after preparing slurry having a foaming agent concentration of 200 to 10000 ppm, it may be diluted with slurry containing no foaming agent for adjusting. Additional amount of the foaming agent ranges from 0.1 to 500 ppm.

(4) Wet Grinding of Foaming Agent Added to the Slurry

Next, the slurry in which the concentration of the foaming agent is adjusted is used with one or more beads selected from quartz glass beads having a mean diameter of 0.1 mm to 3 mm, zirconia beads, silicon carbide beads, and alumina beads other than silicon nitride beads. Then, the wet pulverization is further performed until the BET specific surface area of the solid contained in the slurry becomes 2 m²/g or more. It is preferable to carry out wet pulverization until it becomes 4 m²/g or more, more preferably 6 m²/g or more. When the BET specific surface area is smaller than 2m²/g, the strength of the granulated powder is lowered, the granulation is broken, and the yield at the time of oxyhydrogen flame melting is lowered.

The wet pulverization method of the slurry is not particularly limited, and examples of the wet pulverization method include bead mill pulverization, ball mill pulverization, vibration mill pulverization and attritor pulverization. Bead milling is especially desirable.

(5) Spray Drying Granulation

Next, the slurry produced by the above process is spray-dried to obtain granulated powder. The obtained granulated powder has a substantially spherical shape, a mean particle diameter of 30 to 200 μm, and a water content of 3 wt % or less. If the mean particle size is less than 30 μm, the granulated powder will be dispersed during oxyhydrogen flame melting and the yield will deteriorate. If the mean particle size exceeds 200 μm, the granulation will be broken, and the particles will be dissipated during oxyhydrogen flame melting and the yield will be deteriorated. When the water content exceeds 3 wt %, the fluidity of the granulated powder deteriorates, and the amount of the granulated powder supplied per unit time during oxyhydrogen flame melting decreases, resulting in poor productivity.

(6) Melting of Granulated Powder

Next, the obtained granulated powder is melted with an oxyhydrogen flame or in a vacuum atmosphere to obtain the opaque quartz glass of the present invention. In melting using an oxyhydrogen flame, water is generated during the reaction of oxygen and hydrogen, so the OH group concentration of the opaque quartz glass tends to be 100 to 1000 ppm, which is higher than that of melting process in a vacuum atmosphere. As water is not generated in melting in a vacuum atmosphere, the OH group concentration is 10 ppm or less, which is lower than that of melting in an oxyhydrogen flame.

Through the above process, the obtained opaque quartz glass ingot is processed by a processing machine such as a band saw, a wire saw, and a core drill which are all usually used when manufacturing a opaque quartz glass.

(7) Purity of Opaque Quartz Glass

The purity of the obtained opaque quartz glass depends on the purity of the raw materials. Consequently the purity of the opaque quartz glass of this invention can be controlled by selecting the silica powder used as the raw material, except for the constituent elements of the beads used for the grinding media.

### Advantages of the Invention

The opaque quartz glass of the present invention is excellent in heat insulating property, mechanical strength, surface smoothness and sealing property, so that it can be especially applicable to various core tubes, jigs and containers such as bell jars, which are used particularly in the semiconductor manufacturing process. More specifically, it can be suitably used as a constituent material of a silicon wafer processing core tube, a flange portion thereof, a heat insulating fin, a silicon melting crucible, or the like. Also, it can be used as a reflector base material for light source lamps of projectors as an optical device part.

### PREFERRED EMBODIMENT OF THE INVENTION

The present invention will be specifically described with reference to the examples described below, but the present invention is not limited to the examples.

### Example 1

Fumed silica (D₁₀: 2.5 μm, D₅₀: 10.1 μm, D₉₀: 28.1 μm) is used as the silica raw material powder. Fumed silica is dispersed in water to form slurry, and the concentration is adjusted to 67 wt %. Next, the prepared fumed silica slurry is put into a bead mill and wet-milled using silicon nitride beads having a mean particle diameter of 2.0 mm until the silicon nitride concentration with respect to the silica powder in the slurry becomes 250 ppm, and the slurry (A) is obtained. On the other hand, slurry (B) with no foaming agent having a silica solid content of 67 wt % is prepared using a silica raw material powder. Then, as the slurry for pulverization and granulation, the slurry (A) is diluted with addition of the slurry (B) so that the concentration of silicon nitride with respect to the silica powder in the slurry becomes 1 ppm. The slurry for pulverization and granulation is wet-pulverized using zirconia beads having a mean particle diameter of 2.0 mm until the BET specific surface area becomes 6.0 m²/g.

Next, the slurry for pulverization and granulation produced by the above process is spray-dried to obtain granulated powder. The obtained granulated powder has a mean diameter of 80 μm and water content of 1 wt %. The obtained granulated powder is melted with an oxyhydrogen flame to produce a column-shaped opaque quartz glass ingot.

### Example 2

A column-shaped opaque quartz glass ingot is manufactured according to example 1 except that the amount of silicon nitride added is 5 ppm.

The air bubbles of the obtained opaque quartz glass are observed evenly distributed and the obtained opaque glass looks good.

### Example 3

A column-shaped opaque quartz glass ingot is manufactured according to example 1 except that the amount of silicon nitride added is 0.3 ppm.

Bubbles of the obtained column-shaped opaque quartz glass ingot are observed to be evenly distributed by visual observation, and the obtained opaque glass looks good.

### Example 4

Same as in the example 1, fumed silica as a silica raw material powder is dispersed in water and its concentration is adjusted to 50%. Then, the prepared slurry is put into a bead mill and wet-milled using silicon nitride beads having a mean particle diameter of 0.3 mm until the concentration of silicon nitride in the slurry becomes 1 ppm. Then, the silicon nitride beads are removed, and the slurry to which the foaming agent is added is wet-milled using zirconia beads having a mean particle diameter of 0.3 mm until the BET specific surface area becomes 3.0 m²/g. Next, the slurry prepared by the above described procedure is dried and sprayed to obtain granulated powder. The obtained granulated powder has a mean diameter of 40 μm and a water content of 1 wt %. The obtained granulated powder is melted with an oxyhydrogen flame to produce a column-shaped opaque quartz glass ingot.

Bubbles inside the obtained column-shaped opaque quartz glass ingot are observed to be evenly distributed, and the appearance of the product looks good.

### Example 5

Fumed silica as a silica raw material powder used in the example 1 is dispersed in water and the concentration thereof was adjusted to 70%. Next, the prepared slurry is put into a bead mill and wet-milled using silicon nitride beads having a mean particle diameter of 1.0 mm until the concentration of silicon nitride in the slurry becomes 1 ppm. Then, the silicon nitride beads are removed, and the slurry to which the foaming agent is added is wet-milled using zirconia beads having a mean particle diameter of 1.0 mm until the BET specific surface area becomes 8.0 m²/g.

Next, the slurry prepared by the above procedure is dried and sprayed to obtain granulated powder. The obtained granulated powder has a mean content of 150 μm and a water content of 1 wt %. The obtained granulated powder is melted with an oxyhydrogen flame to produce a column-shaped opaque quartz glass ingot. Bubbles of the obtained column-shaped opaque quartz glass ingot are observed to be evenly distributed and the appearance of the obtained opaque glass looks good.

### Example 6

Fumed silica (D₁₀: 2.5 μm, D₅₀: 10.1 μm, D₉₀: 28.1 μm) is used as the silica raw material powder. Fumed silica is dispersed in water to form slurry, and the concentration is adjusted to 67 wt %. Next, the adjusted slurry is put into a bead mill and wet-milled using silicon nitride beads having a mean particle diameter of 2.0 mm until the silicon nitride concentration with respect to the silica powder in the slurry becomes 250 ppm, and the slurry (A) is prepared. On the other hand, a slurry (B) having a solid content of 67 wt % is prepared using a silica raw material powder containing no foaming agent. Then, as the slurry for pulverization and granulation, the slurry (A) is diluted with the slurry (B) so that the concentration of silicon nitride with respect to the silica powder in the slurry is 1 ppm. The slurry for pulverization and granulation is wet-pulverized using zirconia beads having a mean particle diameter of 2.0 mm until the BET specific surface area becomes 6.0 m²/g. Next, the slurry for pulverization and granulation produced by the above procedure is spray-dried to obtain granulated powder. The obtained granulated powder has a mean diameter of 80 μm and a water content of 1 wt %. The obtained granulated powder is melted with an oxyhydrogen flame to produce a slab-shaped opaque quartz glass ingot.

The air bubbles of the obtained slab-like opaque quartz glass ingot are observed to be uniformly dispersed, which is excellent in appearance.

### Example 7

A slab-shaped opaque quartz glass ingot is manufactured according to example 1 except that the amount of silicon nitride added is 5 ppm.

The air bubbles of the obtained slab-like opaque quartz glass ingot are observed to be uniformly dispersed, which is excellent in appearance as opaque silicon glass.

### Example 8

A slab-shaped opaque quartz glass ingot is manufactured according to example 1 except that the amount of silicon nitride added is 0.3 ppm.

The air bubbles of the slab-shaped opaque quartz glass obtained are observed to be evenly distributed, which is excellent in appearance as opaque silicon glass.

### Example 9

As in example 1, fumed silica as a silica raw material powder is dispersed in water and its concentration is adjusted to 50%. Then, the prepared slurry is put into a bead mill and wet-milled using silicon nitride beads having a mean particle diameter of 0.3 mm until the concentration of silicon nitride in the slurry is 1 ppm. Then, the silicon nitride beads are removed, and the slurry to which the foaming agent is added is wet-milled using zirconia beads having a mean particle diameter of 0.3 mm until the BET specific surface area becomes 3.0 m²/g. Next, the slurry prepared by the above procedure is dried and sprayed to obtain granulated powder. The obtained is dried and sprayed to obtain granulated powder. The obtained granulated powder has a mean diameter of 40 μm and a water content of 1 wt %. The obtained granulated powder is melted with an oxyhydrogen flame to produce a slab-shaped opaque quartz glass ingot.

The air bubbles of the obtained opaque quartz glass are observed to be evenly distributed and which is excellent in appearance as opaque silicon glass.

### Example 10

Fumed silica as silica raw material powder same as the example 1 is dispersed in water and the concentration thereof is adjusted to 70%. Next, the prepared slurry is put into a bead mill and wet-milled using silicon nitride beads having a mean particle diameter of 1.0 mm until the concentration of silicon nitride in the slurry becomes 1 ppm. Then, the silicon nitride beads are removed, and the slurry to which the foaming agent is added is wet-milled using zirconia beads having a mean particle diameter of 1.0 mm until the BET specific surface area becomes 8.0 m²/g. Next, the slurry prepared by the above procedure is dried and sprayed to obtain granulated powder. The obtained granulated powder has a mean content of 150 μm and a water content of 1 wt %. The obtained granulated powder is melted with an oxyhydrogen flame to produce a slab-shaped opaque quartz glass ingot.

The air bubbles of the obtained slab-like opaque quartz glass ingot are observed to be uniformly dispersed and the appearance of the opaque glass looks good.

### Comparative Example 1

Quartz powder having a mean particle size of 150 μm is used as the silica raw material powder. Further, silicon nitride having a mean particle diameter of 2 μm is used as a foaming agent. The mixing concentration of silicon nitride with respect to the crystal powder is 0.2 wt %, and the mixed powder is well mixed and then melted by an oxyhydrogen flame to obtain a column-shaped opaque quartz glass ingot.

### Comparative Example 2

The same fumed silica of example 1 is used as the silica raw material powder. Fumed silica is dispersed in water to form slurry, and its concentration is adjusted to 40 wt %. Next, the prepared fumed silica slurry is put into a bead mill and wet-milled using silicon nitride beads having a mean particle diameter of 3.5 mm until the silicon nitride concentration with respect to the silica powder in the slurry becomes 20000 ppm, and the slurry (A) is obtained. On the other hand, slurry (B) having a solid concentration of 40 wt % is prepared using a silica raw material powder containing no foaming agent.

Then, slurry for pulverization and granulation, slurry (A) is diluted by adding slurry (B) so that the concentration of silicon nitride with respect to the silica powder in the slurry is 0.5 ppm. The slurry for pulverization and granulation is wet-pulverized using zirconia beads having a mean particle diameter of 3.5 mm until the BET specific surface area becomes 1.8 m²/g.

Next, the slurry for pulverization and granulation produced by the above described process is spray-dried to obtain granulated powder. The obtained granulated powder has a mean diameter of 25 μm and water content of 4 wt %. This granulated powder is melted with an oxyhydrogen flame to produce a column-shaped opaque quartz glass ingot.

The BET specific surface area of the slurry is 1.8 m²/g, which is rather small, the strength of the granulated powder is low, the granulated powder becomes collapsible, and consequently the yield of opaque quartz glass with oxyhydrogen flame melting is low.

### Comparative Example 3

The same fumed silica as in example 1 is used as the silica raw material powder. Fumed silica is dispersed in water and its concentration is adjusted to 40%. Next, the concentration-adjusted silica fume slurry is put into a bead mill and wet-milled with silicon nitride beads having a mean particle diameter of 3.5 mm until the concentration of silicon nitride in the slurry reaches 150 ppm, and then the silicon nitride beads are removed. Then, the slurry to which the foaming agent is added is wet pulverized by using zirconia beads having a mean particle diameter of 3.5 mm until the BET specific surface area becomes 1.8 m²/g.

Next, the obtained slurry is spray-dried to obtain granulated powder. The obtained granulated powder has a mean particle size of 250 μm and a water content of 4 wt %. The obtained granulated powder is melted with an oxyhydrogen flame to produce a column-shaped opaque quartz glass ingot.

The BET specific surface area of the slurry is 1.8 m²/g, which is rather small value, and the strength of the granulated powder tends to be low, and the granulated powder is likely to collapse. And the yield of the opaque quartz glass by oxyhydrogen flame is low.

The manufacturing conditions of the above described examples and comparative examples are shown in Table 1, and the characteristics (mean diameter of the foam, density, reflectance, whiteness, bending strength, and surface roughness Ra of baked surface) of the obtained opaque quartz glass ingot are shown in Table 2.

### INDUSTRIAL APPLICABILITY

The opaque quartz glass of the present invention has excellent heat insulating property, mechanical strength, and surface smoothness, and is applicable to members of semiconductor manufacturing equipment, parts of optical equipment, and the like.

Further, according to the method for manufacturing opaque quartz glass of the present invention, it becomes possible to manufacture opaque quartz glass having excellent heat insulating property, mechanical strength, and surface smoothness.

TABLE 1

| | | Mean | | | | | | |
|---|---|---|---|---|---|---|---|---|
| | | diameter | Concen- | Mean | | Mean | | |
| | Concen- | of | tration | diameter | BET | diameter | | |
| | tration | Silicon | of | of | specific | of | | |
| | of | Nitride | Silicon | Zirconia | surface | Granulated | Water | Shape |
| | Slurry | Beads | Nitride | beads | area | Powder | content | of |
| | (wt %) | (mm) | (ppm) | (mm) | (m²/g) | (μm) | (wt %) | Ingot |
| Example 1 | 67 | 2.0 | 1 | 2.0 | 6 | 80 | 1 | Column |
| Example 2 | 67 | 2.0 | 5 | 2.0 | 6 | 80 | 1 | Column |
| Example 3 | 67 | 2.0 | 0.3 | 2.0 | 6 | 80 | 1 | Column |
| Example 4 | 50 | 0.3 | 1 | 0.3 | 3 | 40 | 1 | Column |
| Example 5 | 70 | 1.0 | 1 | 1.0 | 8 | 150 | 1 | Column |
| Example 6 | 67 | 2.0 | 1 | 2.0 | 6 | 80 | 1 | Slab |
| Example 7 | 67 | 2.0 | 5 | 2.0 | 6 | 80 | 1 | Slab |
| Example 8 | 67 | 2.0 | 0.3 | 2.0 | 6 | 80 | 1 | Slab |
| Example 9 | 50 | 0.3 | 1 | 0.3 | 3 | 40 | 1 | Slab |
| Example 10 | 70 | 1.0 | 1 | 1.0 | 8 | 150 | 1 | Slab |
| Comparative | — | — | 0.2 | — | — | — | — | Column |
| Example 1 | | | (wt %) | | | | | |
| Comparative | 40 | 3.5 | 0.5 | 3.5 | 1.8 | 25 | 4 | Column |
| Example 2 | | | | | | | | |
| Comparative | 40 | 3.5 | 150 | 3.5 | 1.8 | 250 | 4 | Column |
| Examaple 3 | | | | | | | | |

TABLE 2

| | Mean | | Density of | | | | Burnished |
|---|---|---|---|---|---|---|---|
| | diameter | | Opaque | | | | surface |
| | of | Shape | quartz | Re- | | Bending | Roughness |
| | air foam | of | glass | flectance | Whit- | Strength | Ra |
| | (μm) | air foam | (g/cm³) | (%) | ness | (MPa) | (μm) |
| Example 1 | 10 | Independent | 2.19 | 86 | 95 | 75 | 0.5 |
| | | Sphere | | | | | |
| Example 2 | 18 | Independent | 2.15 | 81 | 90 | 71 | 0.6 |
| | | Sphere | | | | | |
| Example 3 | 2 | Independent | 2.20 | 88 | 98 | 76 | 0.4 |
| | | Sphere | | | | | |
| Example 4 | 10 | Independent | 2.19 | 86 | 95 | 75 | 0.5 |
| | | Sphere | | | | | |
| Example 5 | 10 | Independent | 2.19 | 86 | 95 | 75 | 0.5 |
| | | Sphere | | | | | |
| Example 6 | 25 | Independent | 2.19 | 82 | 84 | 72 | 0.7 |
| | | Sphere | | | | | |
| Example 7 | 28 | Independent | 2.15 | 80 | 80 | 70 | 0.7 |
| | | Sphere | | | | | |
| Example 8 | 15 | Independent | 2.20 | 83 | 92 | 73 | 0.6 |
| | | Sphere | | | | | |
| Example 9 | 25 | Independent | 2.19 | 82 | 84 | 72 | 0.7 |
| | | Sphere | | | | | |
| Example 10 | 25 | Independent | 2.19 | 82 | 84 | 72 | 0.7 |
| | | Sphere | | | | | |
| Comparative | 80 | Independent | 2.10 | 40 | 50 | 67 | 3.0 |
| Example 1 | | spherical | | | | | |
| Comparative | 1 | Independent | 2.21 | 70 | 70 | 77 | 0.4 |
| Example 2 | | Sphere | | | | | |
| Comparative | 100 | Combined | 1.17 | 70 | 70 | 30 | 50 |
| Examaple 3 | | Sphere | | | | | |

1. Opaque quarts glass having independent spherical shape bubbles with a mean diameter of 2 to 30 μm and a density of 1.90 to 2.20 g/cm³, a whiteness of 80 or more, and a reflectance of light of a wavelength of 0.2 to 3 μm at a thickness of 3 mm is 80% or more.
The whiteness is defined as the lightness measured according to JIS Z 8722 using a colorimeter.

2. The opaque quartz glass according to claim 1, wherein the bending strength is greater 70 MPa or more.

3. The opaque quartz glass according to claim 1, wherein the surface roughness Ra of the baked surface is 0.7 μm or less.

4. A method of manufacturing any one of the opaque quartz glass of claim 1, comprising the steps of mixing a silica powder with a foaming agent and melting the mixture, wherein silicon nitride beads having a mean diameter of 0.1 mm to 3 mm is mixed with the silica powder slurry in which the silica powder dispersed in water at 45 to 75 wt %, pulverizing the silicon nitride beads and generating silicon nitride powder which works as foaming agent and the mixture is melted to manufacture the opaque quartz glass.

5. A method of manufacturing the opaque quartz glass of claim 4, wherein controlling the pulverizing time of silicon nitride beads with silica powder for adjusting the amount of foaming agent generated by abrasion of the silicon nitride beads from 0.1 to 100 ppm, pulverizing the mixture adding one or a plurality of beads selected from the quartz glass beads, zirconia beads, silicon carbide beads, or alumina beads, except the silicon nitride beads, having a mean diameter of 0.1 to 3 mm, abrading the silica powder slurry until the BET specific surface area of the solids in the slurry becomes 2 m²/g or more, and the slurry is spray-dried for obtaining granulated silica powder having a mean particle diameter of 30 to 200 μm and water content of 3 wt % or less, and the granulated silica powder is melted to manufacture the opaque quartz glass.

6. The method of manufacturing an opaque quartz glass of claim 4, wherein diluting the silica powder slurry having silica nitride concentration of 200 to 10000 ppm with respect to the silica powder, thereby adjusting the foaming agent ratio with respect to silica powder from 0.1 to 500 ppm, wet-pulverizing by adding the pulverizing beads having mean diameter of 0.1 mm to 3 mm other than silicon nitride beads until the BET specific surface area of solids contained in the slurry is adjusted to 2 m²/g or more, and the slurry is spray-dried for granulating substantially spherical shapes having a mean particle diameter of 30 to 200 μm and water content of 3 wt % or less.

7. The method of manufacturing the opaque quartz glass according to claim 5, wherein one or a combination of two or more types of a beads mill pulverization method is selected from a ball mill pulverization, a vibration mill pulverization, or an attritor pulverization.

8. The method of manufacturing the opaque quartz glass according to claim 5, wherein the molten raw material is melted with an oxyhydrogen flame.

9. An opaque quartz glass manufactured by the method according to claim 8, which has an OH group concentration of 100 to 1000 ppm.

10. The method of manufacturing opaque quartz glass according to claim 5, wherein the molten raw material is heated and melted under vacuum atmosphere.

11. An opaque quartz glass manufactured according to claim 10, which has an OH group concentration of 10 ppm or less.
